(19) United States
(12) Patent Application Publication
(10) Pub. No.: US 2025/0166656 A1
(43) Pub. Date: May 22, 2025

(54) EMOTION INFORMATION UTILIZATION DEVICE, EMOTION INFORMATION UTILIZATION METHOD, AND PROGRAM

(71) Applicant: NTT TechnoCross Corporation, Tokyo (JP)

(72) Inventors: Kazuhira MATSUI, Tokyo (JP); Toshihiko TANAKA, Tokyo (JP); Kenichi MACHIDA, Tokyo (JP)

(73) Assignee: NTT TechnoCross Corporation, Tokyo (JP)

(21) Appl. No.: 18/839,765

(22) PCT Filed: Feb. 22, 2022
(86) PCT No.: PCT/JP2022/007270

§ 371 Date: Aug. 20, 2024

(51) Int. Cl. G10L 25/63; G06F 16/635; H04M 3/22

(52) U.S. Cl. CPC G10L 25/63; G06F 16/635; H04M 3/2227; H04M 2203/558

(57) ABSTRACT

An emotion information utilization device according to one embodiment includes a database that stores call information including at least emotion information, the emotion information representing an emotion of a speaker for each of predetermined sections; and a search unit configured to search for the call information from the database in accordance with search conditions including at least the section and the emotion information.

### TECHNICAL FIELD

The present invention relates to an emotion information utilization device, an emotion information utilization method, and a program.

### BACKGROUND ART

Techniques of estimating speakers' emotions from their voices or texts are known (e.g., Patent Document 1) and are used for evaluation of operators, support for responses, and the like at contact centers (also called call centers).

### RELATED ART DOCUMENTS

### Patent Documents

Patent Document 1: Japanese Laid-Open Patent Application No. 2012-113542

### SUMMARY OF THE INVENTION

### Problem to Be Solved by the Invention

However, estimation results of emotions (hereinafter also referred to as emotion information) are not fully utilized.

For example, the emotion information of speakers can be estimated during the entire call or for each of their utterances, but cannot be estimated in a unit of a section that is important for analysis, improvement, and the like of support for operators' responses and response quality for customers. Therefore, the emotion information cannot be utilized for analysis, improvement, and the like of support for operators' responses and response quality for customers.

Also, for example, when a call is to be evaluated, it is challenging to interpret whether the call is good or bad from the emotion information. Therefore, the emotion information cannot be fully utilized for evaluation of the call.

One embodiment of the present invention is made in view of the above, and it is an object thereof to utilize the emotion information.

### Means for Solving Problem

In order to achieve the above object, an emotion information utilization device according to one embodiment includes: a database that stores call information including at least emotion information, the emotion information representing an emotion of a speaker for each of predetermined sections; and a search unit configured to search for the call information from the database in accordance with search conditions including at least the section and the emotion information.

### Advantageous Effects of the Invention

The emotion information can be utilized.

### BRIEF DESCRIPTION OF THE DRAWINGS

FIG. 1 is a diagram illustrating one example of an entire configuration of a contact center system according to the present embodiment.

FIG. 2 is a diagram illustrating one example of a functional configuration of an emotion information utilization device according to the present embodiment.

FIG. 3 is a flowchart illustrating one example of a call search process according to the present embodiment.

FIG. 4 is a diagram illustrating one example of a call search screen (part 1).

FIG. 5 is a diagram illustrating one example of a search result screen (part 1).

FIG. 6 is a diagram illustrating one example of a call search screen (part 2).

FIG. 7 is a diagram illustrating one example of a search result screen (part 2).

FIG. 8 is a flowchart illustrating one example of a response support process according to the present embodiment.

FIG. 9 is a diagram illustrating one example of a response support screen.

FIG. 10 is a diagram illustrating one example of an operator monitoring screen.

FIG. 11 is a flowchart illustrating one example of a call evaluation process according to the present embodiment.

### EMBODIMENTS FOR CARRYING OUT THE INVENTION

One embodiment of the present invention will be described below. The present embodiment describes a contact center system 1 that is intended for a contact center. The contact center system 1 is configured to estimate emotions of two persons (an operator and a customer) during a call, and utilize obtained estimation results, i.e., the emotion information, for supporting operators' responses, analyzing and improving their response quality, evaluating the call, and the like.

Note that the contact center is one example for which the above system is intended for. The above system is also intended for offices and the like in addition to the contact centers. In this case, the above system is applicable to a case of estimating emotions of workers there during a call, and utilizing obtained estimation results, i.e., the emotion information, for supporting their telephone responses, analyzing and improving their telephone response quality, and the like.

In the following, the contact center system 1 that realizes (1) to (3) below will be described.
(1) The emotion information of a speaker is estimated in a unit of a section, and the emotion information is utilized for analysis, improvement, and the like of response quality for customers.
(2) The emotion information of a speaker is estimated in a unit of a section, and the emotion information is utilized for supporting operators' responses during a call.
(3) Calls are modeled from the emotion information of the past calls, and the emotion information of the calls is utilized for interpretation when evaluating a call.

By the above (1), for example, it becomes possible to analyze the response quality with higher accuracy and to improve the response quality more effectively. By the above (2), it becomes possible to support the operators' response more effectively. By the above (3), it becomes possible to readily interpret the evaluation result obtained by evaluating a call.

### Entire Configuration of the Contact Center System 1

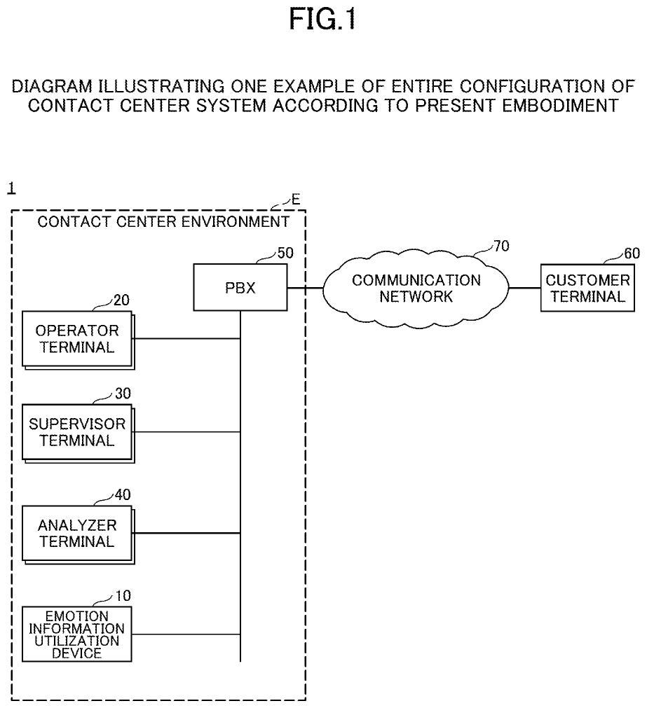

FIG. 1 is a diagram illustrating one example of the entire configuration of a contact center system according to the present embodiment. As illustrated in FIG. 1, the contact center system 1 according to the present embodiment includes an emotion information utilization device 10, one or more operator terminals 20, one or more supervisor terminals 30, one or more analyzer terminals 40, a PBX (Private branch exchange) 50, and a customer terminal 60. Here, the emotion information utilization device 10, the operator terminal 20, the supervisor terminal 30, the analyzer terminal 40, and the PBX 50 are installed in a contact center environment E, which is a system environment of the contact center. The contact center environment E is not limited to a system environment in the same building, but may be, for example, system environments in a plurality of geographically separated buildings.

The emotion information utilization device 10 is configured to convert a voice call between a customer and an operator into a text in real time by means of voice recognition, estimate emotions of the customer and the operator, and utilize obtained estimation results, i.e., the emotion information, for supporting operators' responses, analyzing and improving their response quality, evaluating the call, and the like. Also, the emotion information utilization device 10 provides the operator terminal 20, the supervisor terminal 30, or the analyzer terminal 40 with various screens (e.g., a call search screen, a search result screen, a response support screen, an operator monitoring screen, and the like, which will be described below) for performing response support, analysis and improvement of response quality, and the like.

The operator terminal 20 is various terminals, such as, for example, a PC (personal computer) used by an operator, and functions as an IP (Internet Protocol) telephone set. For example, a response support screen is displayed on the operator terminal 20 during a call with a customer.

The supervisor terminal 30 is various terminals, such as, for example, a PC (personal computer) used by a supervisor. The supervisor terminal 30 is configured to search for the past calls on the call search screen, and display the search results on the search result screen. Also, the supervisor terminal 30 is configured to display the operator monitoring screen configured to monitor a call of an operator with a customer in the background during that call. The supervisor is a person who monitors operators' calls and supports operators' telephone responses when any problem is likely to occur or in accordance with requests from the operators. In general, one supervisor monitors calls of several to several tens of operators.

The analyzer terminal 40 is various terminals, such as a PC (personal computer) used by an analyzer who performs analysis, improvement, and the like of the response quality. The analyzer terminal 40 can search for the past calls on the call search screen, and display the search result on the search result screen. The supervisor may also be the analyzer. In this case, the supervisor terminal 30 also functions as the analyzer terminal 40.

The PBX 50 is a telephone exchange (IP-PBX) and is connected to a communication network 70 including a VoIP (Voice over Internet Protocol) network and a PSTN (Public Switched Telephone Network). The PBX 50 calls the one or more predetermined operator terminals 20 in response to an incoming call from the customer terminal 60, and connects one of the operator terminals 20 responding to that call, to the customer terminal 60.

The customer terminal 60 is various terminals, such as a smartphone, a mobile phone, a fixed telephone, and the like that are used by a customer.

The entire configuration of the contact center system 1 illustrated in FIG. 1 is merely illustrative, and other configurations may be possible. For example, in the example illustrated in FIG. 1, the emotion information utilization device 10 is included in the contact center environment E (i.e., the emotion information utilization device 10 is of an on-premise type). However, all or a part of the functions of the emotion information utilization device 10 may be realized by a cloud service or the like. Similarly, in the example illustrated in FIG. 1, the PBX 50 is a telephone exchange of an on-premise type, but may be realized by a cloud service or the like.

### Functional Configuration of the Emotion Information Utilization Device 10

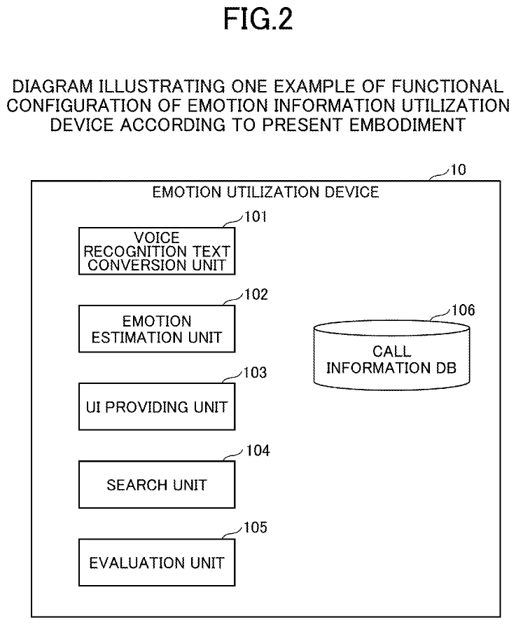

FIG. 2 is a diagram illustrating the functional configuration of the emotion information utilization device 10 according to the present embodiment. As illustrated in FIG. 2, the emotion information utilization device 10 according to the present embodiment includes a voice recognition text conversion unit 101, an emotion estimation unit 102, a UI providing unit 103, a search unit 104, and an evaluation unit 105. Each of these units is realized, for example, through a process performed by a processor, such as a CPU (Central Processing Unit) or the like, that is executed in accordance with one or more programs installed in the emotion information utilization device 10.

The emotion information utilization device 10 according to the present embodiment also includes a call information DB 106. The DB (database) is realized, for example, by an auxiliary storage device, such as an HDD (Hard Disk Drive), an SSD (Solid State Drive), or the like. The DB may be realized, for example, by a database server connected to the emotion information utilization device 10 via a communication network.

The voice recognition text conversion unit 101 is configured to convert a voice call between the operator terminal 20 and the customer terminal 60 into a text by means of voice recognition. At this time, the voice recognition text conversion unit 101 performs voice recognition for each of the speakers for conversion into a text. Thereby, the voice of the operator and the voice of the customer are converted into texts. Hereinafter, the text obtained by means of voice recognition is also referred to as “voice recognition text”.

The emotion estimation unit 102 is configured to estimate the emotion information of the speaker for each of the predetermined sections during a voice call between the operator terminal 20 and the customer terminal 60. The emotion information is information indicating the result obtained by estimating the emotion of the speaker. The emotion includes, for example, “satisfaction”, “dissatisfaction”, “anger”, “normal”, “anxiety”, “doubt”, “convinced”, “pleasure”, and the like. However, the above are illustrative, and the emotion may be more roughly classified into “positive” or “negative”, or may be classified into any other category. Also, the user or the like can make addition, change, deletion, or the like with respect to the definition of the classification of emotions.

However, in addition to estimating the emotion information of the speaker for each of the sections, the emotion estimation unit 102 may, for example, estimate the emotion information of the speaker for each of the utterances or estimate the emotion information of the speaker during the entire call. The emotion estimation unit 102 may, for example, estimate the emotion information of the speaker by an emotion estimation model using an existing deep learning technique or the like. At this time, the emotion estimation unit 102 may estimate the emotion information from the voice during the voice call between the operator terminal 20 and the customer terminal 60 or may estimate the emotion information from the voice recognition text obtained by the voice recognition text conversion unit 101. When estimating the emotion information for each of the sections, the emotion estimation unit 102 may construct an emotion estimation model configured to estimate the emotion information in the unit of sections, and estimate the emotion information for each of the sections by this emotion estimation model. Alternatively, the emotion estimation unit 102 may construct an emotion estimation model configured to estimate the emotion information in the unit of utterances, and estimate the emotion information for each of the sections by estimating the emotion information for each of the utterances by this emotion estimation model and then taking the average of the emotion information of the utterances included in each of the sections.

Here, the emotion estimation unit 102 estimates, for example, the emotion information of the speaker for the sections described in (A) or (B) below.

### (A) Time-Based Sections

For example, the average of typical call durations is obtained, and divided into three: “beginning stage”, “middle stage”, and “end stage”. Then, the emotion information of the speaker is estimated for each of “beginning stage”, “middle stage”, and “end stage”. Specifically, for example, when the average of the typical call durations is “3 minutes”, “beginning stage” is from the beginning of a call (0:00) through 1:00, “middle stage” is from 1:01 through 2:00, and “end stage” is from 2:01 through the end of the call. This division into sections estimates: the customer's emotion information and the operator's emotion information in the range of from the beginning of the call through 1:00; the customer's emotion information and the operator's emotion information in the range of from 1:01 through 2:00; and the customer's emotion information and the operator's emotion information in the range of from 2:01 through the end of the call.

However, dividing the average call duration into “beginning stage”, “middle stage”, and “end stage” is illustrative, and the average call duration may be divided into two: “first half” and “second half” or may be divided into four or more sections.

### (B) Scene (Topic)-Based Sections

A scene is an occasion based on a topic in a call between an operator and a customer. The scene includes, for example: “opening” representing an occasion of a first greeting or the like; “request confirmation” representing an occasion in which a request of the customer is confirmed; “product explanation” representing an occasion in which a product is explained; “status confirmation” representing an occasion in which a customer's status is confirmed; “identity confirmation” representing an occasion in which a customer's identity is confirmed; and “closing” representing an occasion of a final greeting or the like. The scene can be identified, for example, from the voice recognition text or the like by an existing technique.

Specifically, for example, when scenes of a call are “opening”, “request confirmation”, “product explanation”, and “closing”, the customer's emotion information and the operator's emotion information in “opening”, the customer's emotion information and the operator's emotion information in “request confirmation”, the customer's emotion information and the operator's emotion information in “product explanation”, and the customer's emotion information and the operator's emotion information in “closing” are estimated.

### (C) Sections Divided by Call Events

A call event is an event, such as, for example, hold, transfer, or occurrence of a silent state having a predetermined length in time. Specifically, for example, when transfer occurs once in a call, the customer's emotion information and the operator's emotion information are estimated in two sections, i.e., in a section of from the beginning of the call through the transfer and in a section of from the transfer through the end of the call. As another specific example, when transfer occurs once in a call and then hold occurs once in the call, the customer's emotion information and the operator's emotion information are estimated in three sections, i.e., in a section of from the beginning of the call through the transfer, in a section of from the transfer through the hold, and in a section of from the hold through the end of the call.

By estimating the emotion information for each of the sections described in the above (A), for example, it becomes possible to understand change and flow of the emotions of the customer and the operator over time. By estimating the emotion information for each of the sections described in the above (B), for example, it becomes possible to understand the emotions of the customer and the operator for each of the scenes. By estimating the emotion information for each of the sections described in the above (C), for example, it becomes possible to understand the change of the emotions of the customer and the operator before and after the occurrence of the event, such as before and after the transfer of the call to another operator or a supervisor, before and after the hold of the call followed by searching for an FAQ or consulting with a supervisor, or before and after the occurrence of a silent state. Thereby, for example, it becomes possible to perform more accurate analysis of the response quality, more effective improvement of the response quality, more effective response support for operators, and the like.

The UI providing unit 103 is configured to transmit display information for displaying various screens (e.g., the call search screen, the search result screen, the response support screen, the operator monitoring screen, and the like) to the operator terminal 20, the supervisor terminal 30, or the analyzer terminal 40.

The search unit 104 is configured to receive a search request including search conditions designated on the call search screen, and then search for the call information from the call information DB 106 using the search conditions. Also, the search unit 104 is configured to send back the search result to the source of the search request, the search result including the call information searched for from the call information DB 106.

The evaluation unit 105 is configured to create an evaluation model from the emotion information of the previously manually evaluated calls, and evaluate an evaluation target call using this evaluation model.

The call information DB 106 stores call information in the past calls. Here, the call information includes, for example, such information as a call ID that uniquely identifies a call; a date and time of that call; a call duration; an operator ID that uniquely identifies an operator who responds to that call; an operator name; an extension number of an operator; a telephone number of a customer; a voice recognition text of that call; sections of that call; and the emotion information for each of the sections of the call. In addition to these, for example, the emotion information of the speaker for each of the utterances may be included therein, or the emotion information of the speaker during the entire call may be included therein. Also, information indicating a call reason may be included therein. The call reason, also called a purpose of a call, is a reason that the customer made a call. A plurality of call reasons may exist for one call, and in this case, information indicating each of the plurality of call reasons is included in the call information.

The call information is created for each of the calls between the customer and the operator, and stored in the call information DB 106.

### Call Search

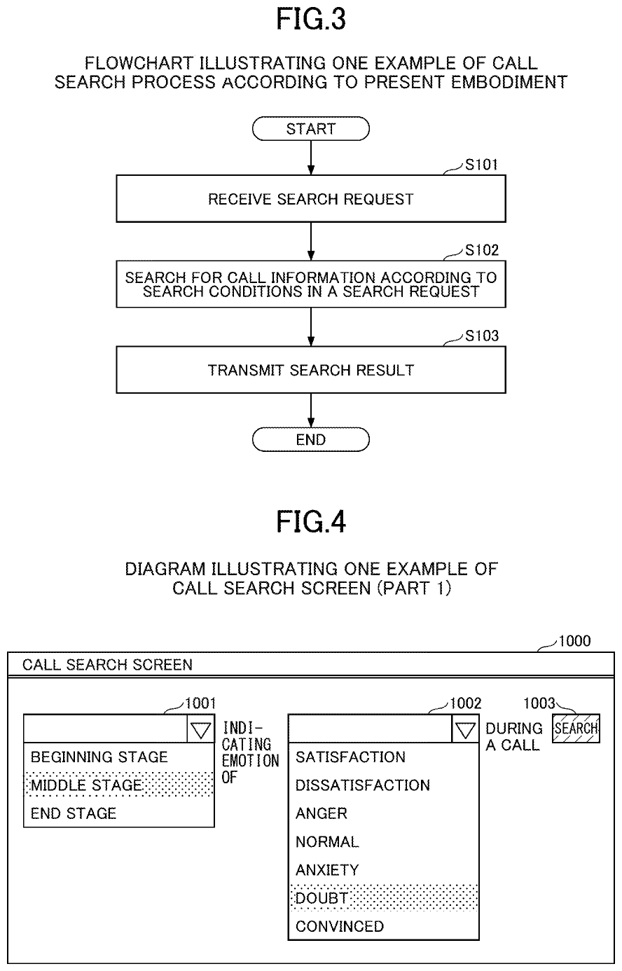

A case of searching for the call information of the past call by utilizing the emotion information for analysis, improvement, and the like of the response quality for customers will be described below. A call search process will be described below with reference to FIG. 3.

The search unit 104 receives a search request from the supervisor terminal 30 or the analyzer terminal 40 (step S101). The search request is transmitted to the emotion information utilization device 10 in response to pressing of a search button after the search conditions are designated on the call search screen displayed on the supervisor terminal 30 or the analyzer terminal 40.

Next, the search unit 104 searches for the call information from the call information DB 106 using the search conditions included in the search request received in step S101 (step S102). As described below, the search conditions include, for example, sections and the emotion information in the sections. This enables search for a call in which an emotion is estimated in a section.

Then, the search unit 104 transmits the search result including the call information obtained in step S102 to the supervisor terminal 30 or the analyzer terminal 40 that is the source of the search request (step S103). The search unit 104 may transmit not the call information itself but the search result including a part of the information included in the call information (e.g., a call ID, a call duration, an operator ID, an operator name, each section, the emotion information for each section, and the like).

### Examples of Call Search Screen and Search Result Screen (Part 1)

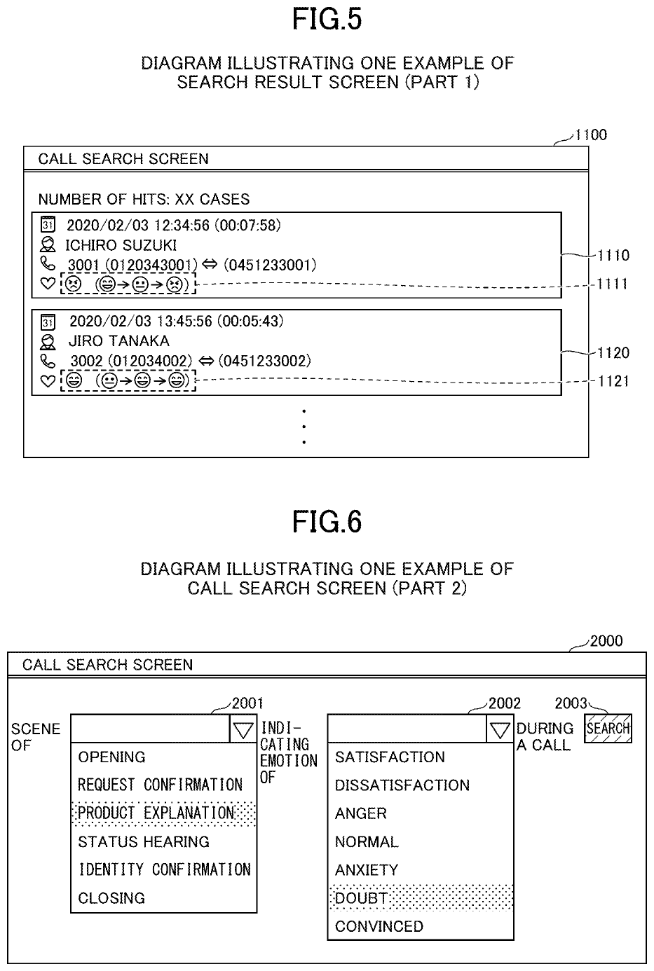

FIGS. 4 and 5 illustrate examples of the call search screen and the search result screen that are displayed in the case of estimating the emotion information during the entire call and the emotion information for each of the sections of the above (A). This call search screen and this search result screen are displayed on the supervisor terminal 30 or the analyzer terminal 40 in accordance with the display information created and transmitted by the UI providing unit 103 (display information on the call search screen and display information on the search result screen).

A call search screen 1000 illustrated in FIG. 4 includes a section designation field 1001, an emotion designation field 1002, and a search button 1003. In the section designation field 1001, a time-based section (“beginning stage”, “middle stage”, or “end stage” in the example illustrated in FIG. 4) can be selected and designated as a search condition. In the emotion designation field 1002, the emotion of the customer (“satisfaction”, “dissatisfaction”, “anger”, “normal”, “anxiety”, “doubt”, and “convinced” in the example illustrated in FIG. 4) in the section designated in the section designation field 1001 can be selected and designated as a search condition. The search button 1003 is a button configured to transmit a search request. The supervisor or the analyzer designates the section and the emotion in the section designation field 1001 and the emotion designation field 1002, and then presses the search button 1003. Thereby, a search request including the section and the emotion designated in the section designation field 1001 and the emotion designation field 1002 as the search conditions is transmitted from the supervisor terminal 30 or the analyzer terminal 40 to the emotion information utilization device 10.

In the example illustrated in FIG. 4, the emotion of the customer is designated in the emotion designation field 1002. However, for example, a field for designating a speaker (operator or customer) may be provided separately, and the emotion of that speaker is designated in the emotion designation field 1002. In the emotion designation field 1002, for example, “positive” or “negative” may be able to be designated. Also, a plurality of sets of the time-based section and the emotion in that section may be able to be designated (e.g., such a search condition as (“beginning stage”, “anger”) in conjunction with (“end stage”, “satisfaction”) may be able to be designated). Further, it may be possible to designate search conditions, such as a condition that the emotion changes in a plurality of time-based sections (e.g., change in emotion between “middle stage” and “end stage”), a condition that the same emotion continues in a plurality of time-based sections (e.g., the same emotion continues from “beginning stage” through “end stage”), and the like.

Upon receiving the search result for the above search request from the emotion information utilization device 10, for example, a search result screen 1100 illustrated in FIG. 5 is displayed on the supervisor terminal 30 or the analyzer terminal 40. The search result screen 1100 illustrated in FIG. 5 includes search result fields 1110 and 1120 that display the contents of the call information included in the search result.

The search result fields 1110 and 1120 each display a date and time of a call, a call duration, an operator name, an extension number of an operator, and a telephone number of a customer. Also, the search result fields 1110 and 1120 include emotion estimation result fields 1111 and 1121, respectively.

For example, in the emotion estimation result field 1111 of the search result field 1110, an icon representing the emotion information of the customer during the entire call is displayed, and an icon representing the emotion information of the customer for each of the three sections (“beginning stage”, “middle stage”, and “end stage”) is displayed in parentheses. In the example illustrated in FIG. 5, the emotion information of the customer during the entire call is “anger”, the emotion information of the customer in “beginning stage” is “satisfaction”, the emotion information of the customer in “middle stage” is “normal”, and the emotion information of the customer in “end stage” is “anger”. This indicates that the emotion of the customer changes from “satisfaction” to “normal” to “anger”.

Similarly, for example, in the emotion estimation result field 1121 of the search result field 1120, an icon representing the emotion information of the customer during the entire call is displayed, and an icon representing the emotion information of the customer in each of the three sections (“beginning stage”, “middle stage”, and “end stage”) is displayed in parentheses. In the example illustrated in FIG. 5, the emotion information of the customer during the entire call is “satisfaction”, the emotion information of the customer in “beginning stage” is “normal”, the emotion information of the customer in “middle stage” is “satisfaction”, and the emotion information of the customer in “end stage” is “satisfaction”. This indicates that the emotion of the customer changes from “normal” to “satisfaction” to “satisfaction”.

When the search result field 1110 or the search result field 1120 is selected, more detailed contents of the call information corresponding to the selected search result field are displayed.

In this manner, the supervisor or the analyzer can use the time-based section and the emotion in the time-based section (especially, the emotion of the customer) as a search condition, thereby searching for the past call that matches the search condition. Thereby, it is possible to extract a call or the like in which the customer is angry in a specific time-based section (e.g., in the end stage of the call). This can be useful for designing a measure for improving such a call, educating an operator, and the like.

Also, a plurality of sets of the section and the emotion, such as (“beginning stage”, “anger”) in conjunction with (“end stage”, “satisfaction”) can be designated as a search condition. Thus, it is possible to extract, for example, a call in which the customer is angry in the beginning stage but is satisfied in the end stage. This can be useful for evaluating such a call as an excellent call, educating an operator, and the like.

Also, for example, only when the emotion information of the customer during the entire call or in the newest section matches a specific condition, the search result field 1110 may display the emotion information during the entire call or in the section prior to the newest section. Here, examples of the specific condition include: a condition that the emotion information of the customer in the newest section is “negative” or a specific emotion; a condition that the emotion information other than negative changes to negative; a condition that the negative or specific emotion continues in a plurality of sections; a condition that a specific emotion is seen in a section representing a specific scene; and the like. At this time, the specific scene or the specific emotion may be designated by the supervisor, the analyzer, or the like.

Thereby, when the specific condition is not matched, the call of interest is regarded as having no problem, and the display of change of the emotion information is omitted. Thus, the amount of information is reduced, thereby reducing the burden of confirmation on the supervisor or the analyzer. In other words, a part of the display is omitted for a call that need not be paid attention to, and the supervisor or the analyzer can more readily confirm a call that needs be paid attention to.

The above specific condition is a condition for omitting a part of the display for a call having no problem. Conversely, when it is desired to omit a part of the display for a call other than an excellent call, for example, the specific condition may be a condition that the emotion information other than positive changes to positive, a condition that the positive or specific emotion continues in a plurality of sections, or the like.

### Examples of Call Search Screens and Search Result Screen (Part 2)

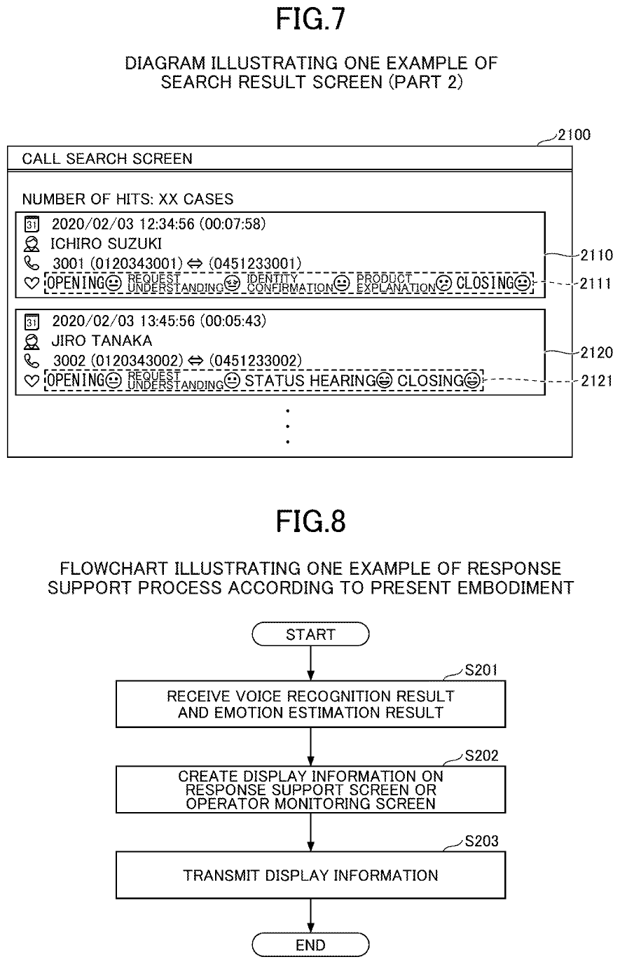

FIGS. 6 and 7 illustrate examples of the call search screen and the search result screen that are displayed in the case of estimating the emotion information for each of the sections of the above (B). This call search screen and this search result screen are displayed on the supervisor terminal 30 or the analyzer terminal 40 in accordance with the display information created and transmitted by the UI providing unit 103 (display information on the call search screen and display information on the search result screen).

A call search screen 2000 illustrated in FIG. 6 includes a section designation field 2001, an emotion designation field 2002, and a search button 2003. In the section designation field 2001, a scene (“opening”, “request confirmation”, “product explanation”, “status hearing”, “identify confirmation”, or “closing” in the example illustrated in FIG. 6) can be selected and designated as a search condition. In the emotion designation field 2002, the emotion of the customer (“satisfaction”, “dissatisfaction”, “anger”, “normal”, “anxiety”, “doubt”, and “convinced” in the example illustrated in FIG. 6) in the scene (section) designated in the section designation field 2001 can be selected and designated as a search condition. The search button 2003 is a button configured to transmit a search request. The supervisor or the analyzer designates the scene (section) and the emotion in the section designation field 2001 and the emotion designation field 2002, and then presses the search button 2003. Thereby, a search request including the scene (section) and the emotion designated in the section designation field 2001 and the emotion designation field 2002 as the search conditions is transmitted from the supervisor terminal 30 or the analyzer terminal 40 to the emotion information utilization device 10.

In the example illustrated in FIG. 6, the emotion of the customer is designated in the emotion designation field 2002. However, for example, a field for designating a speaker (operator or customer) may be provided separately, and the emotion of that speaker is designated in the emotion designation field 2002. Also, a plurality of sets of the scene (section) and the emotion in that section may be able to be designated (e.g., such a search condition as (“opening”, “anger”) in conjunction with (“closing”, “satisfaction”) may be able to be designated).

Upon receiving the search result for the above search request from the emotion information utilization device 10, for example, a search result screen 2100 illustrated in FIG. 7 is displayed on the supervisor terminal 30 or the analyzer terminal 40. The search result screen 2100 illustrated in FIG. 7 includes search result fields 2110 and 2120 that display the contents of the call information included in the search result.

The search result fields 2110 and 2120 each display a date and time of a call, a call duration, an operator name, an extension number of an operator, and a telephone number of a customer. Also, the search result fields 2110 and 2120 include emotion estimation result fields 2111 and 2121, respectively.

For example, in the emotion estimation result field 2111 of the search result field 2110, an icon representing the emotion information of the customer in each of the scenes of the call is displayed. In the example illustrated in FIG. 7, the emotion information of the customer in “opening” is “normal”, the emotion information of the customer in “request understanding” is “dissatisfaction”, the emotion information of the customer in “identity confirmation” is “normal”, the emotion information of the customer in “product explanation” is “doubt”, and the emotion information of the customer in “closing” is “normal”.

Similarly, for example, in the emotion estimation result field 2121 of the search result field 2120, an icon representing the emotion information of the customer in each of the scenes of the call is displayed. In the example illustrated in FIG. 7, the emotion information of the customer in “opening” is “normal”, the emotion information of the customer in “request understanding” is “normal”, the emotion information of the customer in “status hearing” is “satisfaction”, and the emotion information of the customer in “closing” is “satisfaction”.

When the search result field 2110 or the search result field 2120 is selected, more detailed contents of the call information corresponding to the selected search result field are displayed.

In this manner, the supervisor or the analyzer can use the scene-based section and the emotion in the scene-based section (especially, the emotion of the customer) as a search condition, thereby searching for the past call that matches the search condition. Thereby, it is possible to extract a call or the like in which the customer is angry in a specific scene. This can be useful for designing a measure for improving such a call, educating an operator, improving a talk script, and the like. The talk script is, for example, a manual (or script) that describes, for example, the contents that should be uttered by operators for each of the scenes.

Also, a plurality of sets of the section and the emotion, such as (“opening”, “anger”) in conjunction with (“closing”, “satisfaction”) can be designated as a search condition. Thus, it is possible to extract, for example, a call in which the customer is angry in the opening but is satisfied in the closing. This can be useful for evaluating such a call as an excellent call, educating an operator, and the like.

### Response Support

The following describes a case of utilizing the emotion information to display the customer's emotion on the operator terminal 20 in real time or display, in real time, the customer's emotion on the supervisor terminal 30 of the supervisor who is monitoring the operator, in order to support the operator's response during a call with a customer. In the following, a response support process will be described below with reference to FIG. 8. The following response support process is repeatedly performed at predetermined time intervals (e.g., every few seconds) during a call between the customer and the operator.

The UI providing unit 103 receives: the voice recognition text obtained by the voice recognition text conversion unit 101 from a predetermined past point-of-time to the current point of time; and the emotion information estimated by the emotion estimation unit 102 (step S201). The emotion estimation unit 102 estimates the emotion information of the speaker for each of the utterances and also estimates the emotion information of the speaker for each of the sections.

Next, the UI providing unit 103 creates display information including the voice recognition text and the emotion information received in step S201 (display information on the response support screen, display information on the operator monitoring screen, or both) (step S202). This display information may be display information of the response support screen itself or the operator monitoring screen itself. Alternatively, when they are already displayed on the operator terminal 20 or the supervisor terminal 30, the above display information may be display information indicating differences between the received information and the already displayed response support screen or operator monitoring screen. Also, the display information may include, for example: information to be displayed in an advice display field in the response support screen, which will be described below; and information for notifying an alert on the operator monitoring screen.

The UI providing unit 103 transmits the display information created in step S202 to the operator terminal 20 or the supervisor terminal 30 (step S203).

### Response Support Screen

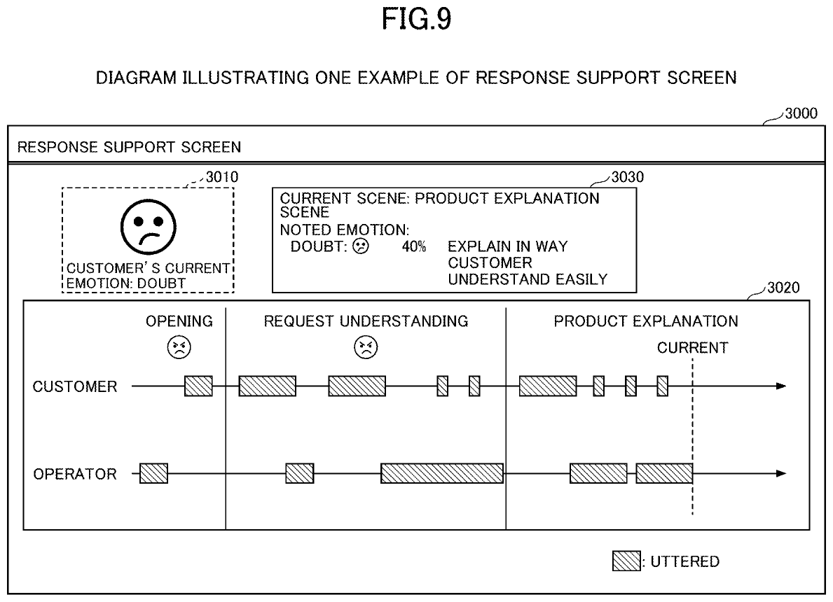

FIG. 9 is a diagram illustrating one example of the response support screen displayed on the operator terminal 20 of an operator. The response support screen is displayed on the operator terminal 20 in accordance with the display information (display information on the response support screen) created and transmitted by the UI providing unit 103.

A response support screen 3000 illustrated in FIG. 9 includes a current emotion display field 3010, a history display field 3020, and an advice display field 3030.

The current emotion display field 3010 displays the customer's current emotion information (“doubt” in the example illustrated in FIG. 9). The current emotion display field 3010 may display, for example, the customer's emotion information in a scene one scene prior to the current scene (i.e., the most-recent scene).

The history display field 3020 displays: the customer's and operator's utterance timings from the beginning of a call to the current; and their emotion information for each of the scenes (sections). In the example illustrated in FIG. 9, the customer's emotion in “opening” is “anger”, the customer's emotion in “request understanding” is “anger”, and the current scene is “product explanation”. Also, a display symbol representing “uttered” is displayed at the timing of the utterance. For example, the voice recognition text or the like corresponding to the display symbol may be displayed by hovering a mouse cursor or the like on the display symbol.

The advice display field 3030 displays the current scene, information for supporting the operator, and the like. The example illustrated in FIG. 9 displays that the current scene is “product explanation” and that the customer's emotion has many “doubts” in the current scene and the operator should explain in a way that the customer can understand the explanation easily.

The scene is used as the section in the example illustrated in FIG. 9. However, the section illustrated in the above (A) or (B) may be used.

In this manner, the operator can confirm the customer's current emotion and the customer's emotion for each of the sections in real time. Also, the operator can confirm in real time information for supporting the operator in accordance with the customer's emotion. Therefore, the operator can respond to the customer appropriately.

In addition, because the customer's emotion for each of the scenes is displayed in real time, for example, the operator can detect a customer's false declaration or the like. As one example, when the operator confirms personal information of the customer in the “identity confirmation” scene, the operator can detect that there is a high possibility of a false declaration when the customer shows much “anxiety” as the customer's emotion. The emotion information utilization device 10 may detect or estimate such a high possibility of a false declaration, and transmit information indicating the detection or estimation result or the like to the operator terminal 20 and display the transmitted information in the advice display field of the response support screen. In addition to this, the advice display field of the response support screen may allow advice to be selected or displayed in accordance with the customer's or operator's emotion information in the current section or in the previous sections. For example, the advice displayed in the advice display field may be selected from those prepared in advance in accordance with, for example, changes in the scene or the emotion information. Alternatively, as the advice displayed in the advice display field, the contents of the response in accordance with the best practice of another excellent operator in the same situation may be selected. Alternatively, as the advice displayed in the advice display field, advice that matches the intended condition, such as the scene, the emotion information, or the like, may be selected.

For example, similar to the search result field 1110 of the search result screen 1100 illustrated in FIG. 5, only when the emotion information of the customer during the entire call or in the newest section matches a specific condition, the history display field 3020 may display information (utterance timing and emotion information) during the entire call or in the section prior to the newest section.

### Operator Monitoring Screen

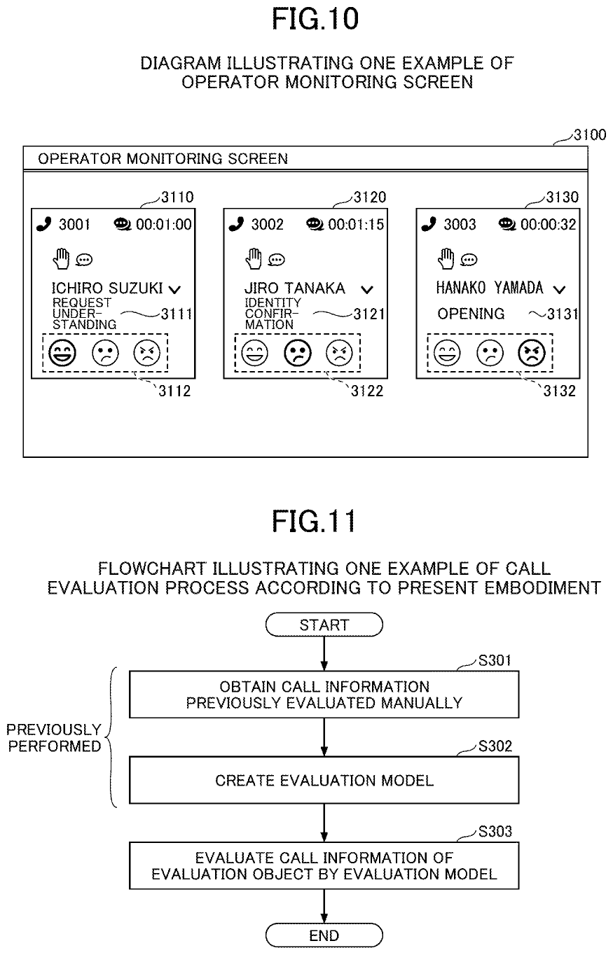

FIG. 10 illustrates one example of an operator monitoring screen displayed on the supervisor terminal 30 of a supervisor. This operator monitoring screen is displayed on the supervisor terminal 30 in accordance with the display information created and transmitted by the UI providing unit 103 (display information of the operator monitoring screen).

An operator monitoring screen 3100 illustrated in FIG. 10 includes call content fields 3110 to 3130 that each display the contents of a call of an operator monitored by the supervisor. The call content fields 3110 to 3130 each display an extension number, a call duration, an operator name, and the like. Also, the call content fields 3110 to 3130 include current scene fields 3111 to 3131 and current emotion fields 3112 to 3132.

For example, the call content field 3110 includes a current scene field 3111 and a current emotion field 3112. The current scene field 3111 displays an icon representing “request understanding”, and the current emotion field 3112 displays an icon representing “satisfaction”. This indicates that the current scene of the call monitored by the call content field 3110 is “request understanding”, and the customer's current emotion is “satisfaction”.

Similarly, for example, the call content field 3120 includes a current scene field 3121 and a current emotion field 3122. The current scene field 3121 displays “identity confirmation”, and the current emotion field 3122 displays an icon representing “doubt”. This indicates that the current scene of the call monitored by the call content field 3120 is “identity confirmation”, and the customer's current emotion is “doubt”.

Similarly, for example, the call content field 3130 includes a current scene field 3131 and a current emotion field 3132. The current scene field 3131 displays “opening”, and the current emotion field 3132 displays an icon representing “anger”. This indicates that the current scene of the call monitored by the call content field 3130 is “opening”, and the customer's current emotion is “anger”.

When any one of the call content fields 3110 to 3130 is selected, more detailed contents of the call corresponding to the selected call content field (e.g., the voice recognition text of that call) are displayed.

In this manner, the supervisor can monitor, in real time, the current scene (section), the customer's current emotion, and the like in the call of the operator who is being monitored by the supervisor. Therefore, for example, by identifying a call that is likely to cause a complaint in view of the customer's emotion and intervening in the call, the supervisor can support the operator of that call.

Also, for example, the supervisor may be notified of some information by a desired method in accordance with the change of the customer's emotion information. As a specific example, an alert (e.g., an alert through blinking, outputting of a sound, or the like) may be indicated on the operator monitoring screen. In one example, when the emotion information is estimated for each of the scenes, the alert may be notified when the customer's emotion changes from something other than “anger” to “anger”. Also, for example, the alert may be notified when the customer's emotion is “anger” in a specific scene (e.g., “identity confirmation”). Further, for example, in order to exclude a call in which a speaker is angry from the beginning of the call, no alert may be notified when the customer's emotion is “anger” even in “opening” even if the customer's emotion is “anger”. Whether or not to notify such an alert may be determined by the emotion information utilization device 10, and information indicating the determination result or the like may be transmitted to the supervisor terminal 30.

### Call Evaluation

In order to facilitate interpretation when evaluating a call, the following describes a case in which the past calls are modeled utilizing the emotion information, and an evaluation target call is evaluated by the created model. A call evaluation process will be described below with reference to FIG. 11. Steps S301 and S302 below are processes to be performed in advance, and step S303 is a process to be performed for each of the evaluation target calls.

The evaluation unit 105 obtains evaluated call information from among the call information DB 106 (step S301). Here, the evaluated call information is previously manually evaluated call information among the call information stored in the call information DB 106. In the following, the evaluated call information of a call manually evaluated as an excellent call will be referred to as “excellent call information”. There are various viewpoints for evaluating whether or not a call is an excellent call. For example, a “call in which very skillful explanation satisfies the customer”, a “call in which very skillful recommendation of goods or services leads to making a contract”, or the like may be evaluated as an excellent call. However, these are illustrative, and the viewpoints for the evaluation are not limited thereto. From a given viewpoint, a call that serves as a model for other operators may be evaluated as an excellent call.

Next, the evaluation unit 105 uses the evaluated call information obtained in step S301, and creates an evaluation model by an existing clustering method, an existing machine learning method, or the like (step S302).

Then, the evaluation unit 105 evaluates call information of the evaluation target call using the evaluation model created in step S303 (step S303).

### Creation Method for Evaluation Model and Evaluation Method for Evaluation Target Call

In the following, the number of pieces of the evaluated call information obtained in step S301 is denoted by N, and the pieces of the evaluated call information are denoted by xₙ (n=1, . . . , N). Further, assuming that the emotion information is estimated for each of the utterances, the emotion information of the k^{th} utterance included in the evaluated call information xₙ is denoted by eₙₖ, the speaker who made the k^{th} utterance is denoted by pₙₖ, and the point-of-time of the k^{th} utterance is denoted by tₙₖ. The call reason of the evaluated call information xₙ is denoted by rₙ.

At this time, the n^{th} evaluated call information is denoted by xₙ={rₙ, {(eₙₖ, pₙₖ, tₙₖ)|k=1, . . . , Kₙ}}. Kₙ is the number of utterances included in the n^{th} evaluated call information xₙ. The emotion information eₙₖ may be, for example, a categorical value representing emotion, such as “anger”, “satisfaction”, or “dissatisfaction”, or may be a vector or array having elements that are probabilities or likelihoods of these emotions.

When a plurality of call reasons are included in one piece of the evaluated call information, the evaluated call information is divided for each of the call reasons, and is expressed in the above-described manner. For example, when two call reasons rₙ and r′ₙ are included in the n^{th} evaluated call information xₙ, the evaluated call information xₙ may be divided into {rₙ, {(eₙₖ, pₙₖ, tₙₖ)|k=1, . . . , K′ₙ}}and {r′ₙ, {(eₙₖ, pₙₖ, tₙₖ)|k=K′ₙ+1, . . . , Kₙ}}. Then, the former may be reset to xₙ={rₙ, {(eₙₖ, pₙₖ, tₙₖ)|k=1, . . . , Kₙ}} and the latter may be renumbered to the N+1ₜₕ evaluated call information x_{N+1}={rₙ₊₁, {(e_{N+1,k}, p_{N+1,k}, t_{N+1, k})|k=1, . . . , K_{N+1}}}.

In the following, the evaluated call information including a plurality of call reasons is assumed to have been divided in the above-described manner, and the number of pieces of the evaluated call information is denoted as N.

### Creation Method for Evaluation Model and Evaluation Method for Evaluation Target Call, Part 1

In the following, excellent call information is assumed to be obtained as the evaluated call information in step S302 of FIG. 10.

### Training Data Used for Creation of Evaluation Model

One of the following (a) to (d) is used as training data.
(a) xₙ={eₙₖ|k=1, . . . , Kₙ} (n=1, . . . , N) is used as the training data. That is, only the sequence of the emotion information included in the excellent call information is used as the training data.
(b) xₙ={(eₙₖ, pₙₖ)|k=1, . . . , Kₙ} (n=1, . . . , N) is used as the training data. That is, only the sequence of the speaker and the emotion information included in the excellent call information is used as the training data.
(c) xₙ={(eₙₖ, pₙₖ, tₙₖ)|k=1, . . . , Kₙ} (n=1, . . . , N) is used as the training data. That is, the sequence of the speaker, the point-of-time of the utterance, and the emotion information included in the excellent call information is used as the training data.
(d) xₙ={rₙ, {(eₙₖ, pₙₖ, tₙₖ)|k=1, . . . , Kₙ}} (n=1, . . . , N) is used as the training data. That is, the call reason included in the excellent call information is also used as the training data, in addition to the speaker, the point-of-time of the utterance, and the emotion information included in the excellent call information.

### Modeling Method

For example, a clustering method for variable-length sequences is used. Thereby, clusters are constructed from the training data, and these clusters become an evaluation model.

### Evaluation data

When the evaluation target call information is denoted as x={r, {(eₖ, pₖ, tₖ)|k=1, . . . , K}} (where K is the number of utterances), a similar format to that of the training data is used as the evaluation data. That is, when the above (a) is used as the training data, x={eₖ|k=1, . . . , K} is used as the evaluation data; when the above (b) is used as the training data, x={(eₖ, pₖ)|k=1, . . . , K} is used as the evaluation data; when the above (c) is used as the training data, x={(eₖ, pₖ, tₖ)|k=1, . . . , K} is used as the evaluation data; and when the above (d) is used as the training data, x={r, {(eₖ, pₖ, tₖ)|k=1, . . . , K}} is used as the evaluation data.

### Evaluation Method

When the distance to the centroid of any cluster is small (e.g., when this distance is equal to or less than a predetermined threshold), the evaluation target call is evaluated as an excellent call. Otherwise, the evaluation target call is evaluated as being not an excellent call. Also, in accordance with the cluster in which the distance to the centroid is small, why the evaluation target call is an excellent call (e.g., a “call in which very skillful explanation satisfies the customer”, a “call in which very skillful recommendation of goods or services leads to making a contract”, or the like) is evaluated.

### Creation Method for Evaluation Model and Evaluation Method for Evaluation Target Call, Part 2

In the following, excellent call information, call information of a call evaluated as being not bad (hereinafter referred to as normal call information), and call information of a call evaluated as a call requiring improvement (hereinafter referred to as call information requiring improvement) are assumed to be obtained as the evaluated call information in step S302 of FIG. 10. However, three types of call information, i.e., the excellent call information, the normal call information, and the call information requiring improvement, need not necessarily be obtained. For example, when it is intended to evaluate whether or not the evaluation target call is an excellent call, it is enough to obtain only the excellent call information and the normal call information. Meanwhile, when it is intended to evaluate whether or not the evaluation target call is a call requiring improvement, it is enough to obtain only the normal call information and the call information requiring improvement.

### Training Data Used for Creation of Evaluation Model

One of the above (a) to (d) is used as training data. The training data are provided with, as supervised data, information indicating that the call of interest is evaluated as “excellent call”, “normal call”, or “call requiring improvement”.

### Modeling Method

For example, a classification model configured to classify the call of interest into three classes, i.e., “excellent call”, “normal call”, or “call requiring improvement” is constructed as an evaluation model through supervised learning using a machine learning method. For example, when it is intended to evaluate whether or not the evaluation target call is an excellent call, a classification model configured to classify the evaluation target call into two classes, i.e., “excellent call” or “normal call” (other than the excellent call) may be constructed as an evaluation model. Meanwhile, when it is intended to evaluate whether or not the evaluation target call is a call requiring improvement, a classification model configured to classify the evaluation target call into two classes, i.e., “normal call” or “call requiring improvement” may be constructed as an evaluation model.

### Evaluation Data

When the evaluation target call information is denoted as x={r, {(eₖ, pₖ, tₖ)|k=1, . . . , K}} (where K is the number of utterances), a similar format to that of the training data is used as the evaluation data.

### Evaluation Method

From an output obtained by inputting the evaluation data to the evaluation model, evaluation is performed on whether the evaluation target call is “excellent call”, “normal call”, or “call requiring improvement”.

As described above, when evaluating the call, the evaluation result can be readily interpreted. The interpretation result can be utilized for various analyses (e.g., analysis for improving response quality) and evaluations of operators (e.g., commending excellent operators, and the like).

The present invention is not limited to the above specifically disclosed embodiments. Various modifications and changes, and combinations with existing techniques can be made without departing from the scope of the claims as recited.

### REFERENCE SIGNS LIST

1 Contact center system
10 Emotion information utilization device
20 Operator terminal
30 Supervisor terminal
40 Analyzer terminal
50 PBX
60 Customer terminal
70 Communication network
101 Voice recognition text conversion unit
102 Emotion estimation unit
103 UI providing unit
104 Search unit
105 Evaluation unit
106 Call information DB

1. An emotion information utilization device, comprising:
a database that stores call information including at least emotion information, the emotion information representing an emotion of a speaker for each predetermined section of a plurality of predetermined sections in a conversation;
a memory; and
at least one processor connected to the memory, wherein
the processor is configured to:
search for the call information from the database in accordance with search conditions including at least a section and emotion information; and
interactively determine, based on the call information, a quality value of a call.

2. The emotion information utilization device according to claim 1, wherein
the section is
a time-based section,
a scene-based section that represents an occasion based on a topic in a call corresponding to the call information, or
a section in a unit of the call divided by a predetermined call event.

3. The emotion information utilization device according to claim 1, wherein
the processor is configured to
display the emotion information on a first display, the emotion information being included in the call information found.

4. The emotion information utilization device according to claim 3,
the processor is configured to
display the emotion information for each of the sections on the first display, the emotion information being included in the call information found.

5. The emotion information utilization device according to claim 4,
in a case in which the emotion information in a newest section among the emotion information for each of the sections included in the call information found is the emotion information representing a negative emotion, the processor is configured to display, on the first display,
the emotion information in the newest section, and
the emotion information in the section prior to the newest section.

6. The emotion information utilization device according to claim 3, wherein
the processor is configured to
display the emotion information on the first display included in a first terminal, the first terminal being connected to the emotion information utilization device via a communication network.

7. The emotion information utilization device according to claim 3, wherein
the processor is configured to
estimate, from utterances in a call between a first speaker and a second speaker, the emotion information for each of the sections and the emotion information for each of the utterances, and
display, on a second display, the emotion information for each of the sections and the emotion information for each of the utterances during the call.

8. The emotion information utilization device according to claim 7, wherein
in a case in which specific emotion information is estimated in a specific section, the processor is configured to
notify a predetermined notification destination of predetermined information.

9. The emotion information utilization device according to claim 8, wherein
in a case in which the specific emotion information is estimated in the specific section, and the specific emotion information is estimated in an initial section of the call, the processor is configured not to
notify the predetermined notification destination of the predetermined information.

10. The emotion information utilization device according to claim 8, wherein
the processor is configured to
notify the predetermined notification destination of the predetermined information in a case in relation to the emotion information for each of the sections, the case being
a case in which the emotion information other than the emotion information representing a negative emotion changes to the emotion information representing the negative emotion,
a case in which the emotion information other than the emotion information representing a positive emotion changes to the emotion information representing the positive emotion,
a case in which the emotion information representing a negative emotion continues in a section of the sections, or
a case in which the emotion information representing a positive emotion continues in a section of the sections.

11. The emotion information utilization device according to claim 8, wherein
the processor is configured to
notify a second terminal of the predetermined information, the second terminal being connected to the emotion information utilization device via a communication network.

12. The emotion information utilization device according to claim 7, wherein
the processor is configured to create an evaluation model and evaluate call information of an evaluation target call by the evaluation model, the evaluation model being created by modeling the emotion information included in previously manually evaluated call information of the call information stored in the database.

13. The emotion information utilization device according to claim 12, wherein
the processor is configured to
create the evaluation model and evaluate the call information of the evaluation target call by the evaluation model, the evaluation model being created by modeling a sequence of the emotion information for each of the utterances through clustering or machine learning.

14. An emotion information utilization device, comprising:
a database that stores call information including at least emotion information, the emotion information representing an emotion of a speaker for each of predetermined sections;
a memory; and
at least one processor connected to the memory, wherein
the processor is configured to refer to the database and display, on a display, the emotion information included in the call information that matches a predetermined condition.

15. An emotion information utilization method, comprising:
storing, in a database, call information including at least emotion information representing an emotion of a speaker for each of predetermined sections; and
searching for the call information from the database in accordance with search conditions including at least the section and the emotion information,
the storing and the searching being performed by a computer.

16. An emotion information utilization method, comprising:
storing, in a database, call information including at least emotion information representing an emotion of a speaker for each of predetermined sections; and
referring to the database and displaying, on a display, the emotion information included in the call information that matches a predetermined condition,
the storing and the referring being performed by a computer.

17. A non-transitory computer-readable recording medium storing a program that causes a computer to execute:
storing, in a database, call information including at least emotion information representing an emotion of a speaker for each of predetermined sections; and
searching for the call information from the database in accordance with search conditions including at least the section and the emotion information,

18. A non-transitory computer-readable recording medium storing a program that causes a computer to execute:
storing, in a database, call information including at least emotion information representing an emotion of a speaker for each of predetermined sections; and
referring to the database and displaying, on a display, the emotion information included in the call information that matches a predetermined condition.
